(19) United States
(12) Patent Application Publication
(10) Pub. No.: US 2026/0321027 A1
(43) Pub. Date: Oct. 15, 2026

(54) METHOD AND VEHICLE FOR PROCESSING ROAD BOUNDARY

(71) Applicants: HYUNDAI MOTOR COMPANY, Seoul (KR); KIA CORPORATION, Seoul (KR)

(72) Inventor: Yeong Hun KIM, Hwaseong-si (KR)

(21) Appl. No.: 19/635,932

(22) Filed: Apr. 1, 2026

(30) Foreign Application Priority Data
Apr. 2, 2025 (KR) 10-2025-0042778

(51) Int. Cl. G06V 20/56; B60W 60/00; G01S 13/931

(52) U.S. Cl. CPC G06V 20/588; B60W 60/001; G01S 13/931; B60W 2420/403; B60W 2554/20; B60W 2554/801; G01S 2013/93185

(57) ABSTRACT

Disclosed herein a method and vehicle for processing road boundary. The method includes: generating a virtual road boundary based on a valid road boundary generated from point cloud data of a first sensor; determining, based on approximation of the virtual road boundary with a static object perceived by the first sensor to be spaced apart from the valid road boundary, whether to adopt the static object as a boundary candidate; determining, based on the static object being adopted as the boundary candidate, whether an unperceived area of the first sensor between a perceived road boundary on the valid road boundary and the boundary candidate is estimated to be in a presence-non-detection state; generating, based on the unperceived area being estimated to be in the presence-non-detection state, a final road boundary based on the perceived road boundary and the static object.

### CROSS-REFERENCE TO RELATED APPLICATION

This application claims the benefit of priority to Korean Patent Application No. 10-2025-0042778, filed in the Korean Intellectual Property Office on Apr. 2, 2025, the disclosure of which is incorporated herein by reference in its entirety.

### TECHNICAL FIELD

The present disclosure relates to a method and vehicle for processing a road boundary, and more particularly, to a method and vehicle of processing a road boundary that robustly estimate objects related to an unperceived road boundary with sensor performance limitations.

### BACKGROUND

The matters described in this Background section are only for enhancement of understanding of the background of the disclosure, and should not be taken as acknowledgment that they correspond to prior art already known to those skilled in the art.

Autonomous driving functions may be supported in vehicles so that the vehicle controls driving with minimal or no driver intervention.

The vehicle may detect a surrounding environment using various types of heterogeneous sensors and identify a situation around the vehicle based on the detected surrounding environment. The vehicle may establish a control plan for autonomous driving corresponding to the identified situation to control an actuator of the vehicle.

In terms of cost and system simplification, a sensor mounted on the vehicle may mainly include an image sensor and a radar sensor. Here, since the radar sensor is inexpensive compared to a lidar sensor, the vehicle may not include the lidar sensor and may only mount the radar sensor.

The radar sensor may provide sparse point cloud data. The sensing performance of the radar sensor depends on the shape and reflection characteristics of an object, such that sensor data for the object may be poor or may not be generated.

Autonomous driving may involve techniques to determine the surrounding environment, such as road boundaries, for accurate and safe control. However, when an undetected object or an undetected area occurs due to sensor performance limitations, the determination of road boundaries using radar sensors may be limited or discontinuous. Control logic that utilizes discontinuously determined road boundaries may cause performance degradation.

### SUMMARY

The various examples of the present disclosure are to provide a method and vehicle of processing a road boundary that robustly estimate objects related to an unperceived road boundary with sensor performance limitations.

The technical problems to be achieved by the present disclosure are not limited to the above-mentioned technical problems, and other technical problems that are not mentioned will be clearly understood by those skilled in the art to which the present disclosure belongs from the description below.

According to the present disclosure, a method performed by a vehicle may comprise obtaining, via a sensor of the vehicle, point cloud data associated with at least one static object in a surrounding environment of the vehicle, detecting, based on the point cloud data, a road boundary, generating a virtual road boundary by extending the detected road boundary, determining, based on approximation of the virtual road boundary with the at least one static object, whether to select the at least one static object as a boundary candidate, wherein the at least one static object is spaced apart from the detected road boundary, determining whether an unperceived area is in a presence-non-detection state, wherein the unperceived area is an area undetected by the sensor and located between the detected road boundary and the boundary candidate, and wherein the presence-non-detection state is a state in which an object undetected by the sensor is estimated to be present in the surrounding environment, and based on the detected road boundary, the at least one static object, and the unperceived area being in the presence-non-detection state, outputting a signal indicating a final road boundary and controlling, based on the signal, autonomous driving of the vehicle.

A vehicle may comprise a sensor configured to obtain point cloud data associated with at least one static object in a surrounding environment of the vehicle, a driving control circuit configured to control autonomous driving of the vehicle, and a processor circuit configured to cause the vehicle to detect, based on the point cloud data, a road boundary, generate, based on regression line information derived from the detected road boundary, a virtual road boundary, determine, based on whether an approximation condition between a boundary line associated with the at least one static object and the virtual road boundary is satisfied, whether to select the at least one static object as a boundary candidate, determine whether an unperceived area is in a presence-non-detection state, wherein the unperceived area is an area undetected by the sensor and located between the detected road boundary and the boundary candidate, and wherein the presence-non-detection state is a state in which an object undetected by the sensor is determined to be present in the surrounding environment, and based on the detected road boundary, the at least one static object, and the unperceived area being in the presence-non-detection state, output a signal indicating a final road boundary and control, via the driving control circuit and based on the signal, autonomous driving of the vehicle.

The vehicle may further be characterized in that the regression line information is derived by fitting a regression line to a plurality of boundary points included in the detected road boundary, and that the virtual road boundary is generated by extending the regression line beyond an end portion of the detected road boundary. The vehicle may further be characterized in that the approximation condition is satisfied when a distance between a first point and a second point is less than or equal to a predetermined threshold distance, wherein the first point corresponds to an endpoint of an estimated boundary line associated with the at least one static object, and wherein the second point corresponds to an endpoint of the virtual road boundary. The vehicle may further be characterized in that the unperceived area is determined to be in the presence-non-detection state based on a quantity of times an object in the unperceived area undetected by the sensor being less than or equal to an absence-state threshold value.

According to the present disclosure, a vehicle may comprise a sensor configured to obtain point cloud data associated with at least one static object in a surrounding environment of the vehicle, a processor, and a memory storing at least one instruction that, when executed by the processor, is configured to cause the vehicle to detect, based on the point cloud data, a road boundary, generate a virtual road boundary by extending the detected road boundary, determine, based on approximation of the virtual road boundary with the at least one static object, whether to select the at least one static object as a boundary candidate, wherein the at least one static object is spaced apart from the detected road boundary, determine whether an unperceived area is in a presence-non-detection state, wherein the unperceived area is an area undetected by the sensor and located between the detected road boundary and the boundary candidate, and wherein the presence-non-detection state is a state in which an object undetected by the sensor is estimated to be present in the surrounding environment, and based on the detected road boundary, the at least one static object, and the unperceived area being in the presence-non-detection state, output a signal indicating a final road boundary and control, based on the signal, autonomous driving of the vehicle.

The vehicle may further be characterized in that the detected road boundary may comprise at least one of a perceived road boundary and a preceding final road boundary, wherein the perceived road boundary is determined from the point cloud data and used as the detected road boundary, and wherein the preceding final road boundary is a final road boundary generated based on point cloud data acquired at a preceding time. The vehicle may further be characterized in that the virtual road boundary is generated by extending the detected road boundary using regression line information, and wherein the regression line information is derived from the detected road boundary. The vehicle may further be characterized in that, in determining whether to select the at least one static object as the boundary candidate, the at least one instruction, when executed by the processor, is configured to cause the vehicle to select the at least one static object as the boundary candidate based on a distance between a first point and a second point satisfying a threshold distance, wherein the first point corresponds to an endpoint of an estimated boundary line associated with the at least one static object, and wherein the second point corresponds to an endpoint of the virtual road boundary.

The vehicle may further be characterized in that the virtual road boundary may comprise a first virtual road boundary and a second virtual road boundary, wherein the first virtual road boundary is generated based on a first detected road boundary determined from the point cloud data, and wherein the second virtual road boundary is generated based on a second detected road boundary determined by image data, wherein the image data is obtained from a second sensor configured to detect the surrounding environment, and wherein, in determining whether to select the at least one static object as the boundary candidate, the at least one instruction, when executed by the processor, is configured to cause the vehicle to select, based on the at least one static object satisfying an approximation condition with at least one of the first virtual road boundary or the second virtual road boundary, the at least one static object as the boundary candidate. The vehicle may further be characterized in that the second virtual road boundary is generated by extending a detection range of the second sensor to correspond to a detection range of the sensor, and wherein the detection range of the sensor is greater than the detection range of the second sensor.

The vehicle may further be characterized in that, in determining whether an unperceived area is in the presence-non-detection state, the at least one instruction, when executed by the processor, is configured to cause the vehicle to determine that the unperceived area is in the presence-non-detection state based on a number of times an object in the unperceived area not detected by the sensor being less than or equal to an absence-state threshold value. The vehicle may further be characterized in that the at least one instruction, when executed by the processor, is configured to cause the vehicle to determine the at least one static object as a portion of the road boundary and generate the final road boundary by connecting the portion of the road boundary and the detected road boundary so as to merge the at least one static object with the detected road boundary. The vehicle may further be characterized in that, in determining whether the unperceived area is in the presence-non-detection state, the at least one instruction, when executed by the processor, is configured to determine that, based on the unperceived area determined to be not in the presence-non-detection state, the unperceived area is in an absence-non-detection state, wherein the absence-non-detection state is a state in which an object is not detected by the sensor and is determined to be actually absent, and generate the final road boundary based on the unperceived area being determined to be in the absence-non-detection state and the detected road boundary. The vehicle may further be characterized in that the detected road boundary is identified by detecting a road structure installed in a predetermined form on a road in the surrounding environment of the vehicle.

The features briefly summarized above with respect to the present disclosure are merely exemplary examples of the detailed description of the present disclosure described below, and do not limit the scope of the present disclosure.

### BRIEF DESCRIPTION OF THE DRAWINGS

The above and other objects, features and advantages of the present disclosure will become more apparent to those of ordinary skill in the art by describing one or more example examples thereof in detail with reference to the accompanying drawings, in which:

FIG. 1 shows an example that a vehicle communicates with another device to transmit and receive data.

FIG. 2 shows exemplary modules that constitute the vehicle.

FIG. 3 shows an example of generation and management of a road boundary based on sensor data.

FIG. 4 shows exemplary modules that constitute a server.

FIG. 5 shows an exemplary method for processing a road boundary.

FIG. 6, FIG. 7, and FIG. 8 show examples of a virtual road boundary.

FIG. 9 shows an example related to determination of a state in an unperceived area.

FIG. 10 shows an example related to determination of a state in an unperceived area.

FIG. 11 shows an example related to generation of a final road boundary.

FIG. 12 shows an example related to generation of the final road boundary.

FIG. 13 shows an example computing system.

### DETAILED DESCRIPTION

Hereinafter, exemplary examples of the present disclosure will be described in detail with reference to the accompanying drawings so that those skilled in the art may easily implement the present disclosure. However, the present disclosure may be implemented in various different ways and is not limited to the examples described therein.

In describing exemplary examples of the present disclosure, well-known functions or constructions will not be described in detail since they may unnecessarily obscure the understanding of the present disclosure. The same constituent elements in the drawings are denoted by the same reference numerals, and a repeated description of the same elements will be omitted.

In the present disclosure, when an element is simply referred to as being “connected to”, “coupled to” or “linked to” another element, this may mean that an element is “directly connected to”, “directly coupled to” or “directly linked to” another element or is connected to, coupled to or linked to another element with the other element intervening therebetween. In addition, when an element “includes” or “has” another element, this means that one element may further include another element without excluding another component unless specifically stated otherwise.

In the present disclosure, the terms first, second, etc. are only used to distinguish one element from another and do not limit the order or the degree of importance between the elements unless specifically mentioned. Accordingly, a first element in an example could be termed a second element in another example, and, similarly, a second element in an example could be termed a first element in another example, without departing from the scope of the present disclosure.

In the present disclosure, elements that are distinguished from each other are for clearly describing each feature, and do not necessarily mean that the elements are separated. For example, a plurality of elements may be integrated in one hardware or software unit, or one element may be distributed and formed in a plurality of hardware or software units. Therefore, even if not mentioned otherwise, such integrated or distributed examples are included in the scope of the present disclosure.

In the present disclosure, elements described in various examples do not necessarily mean essential elements, and some of them may be optional elements. Therefore, an example composed of a subset of elements described in an example is also included in the scope of the present disclosure. In addition, examples including other elements in addition to the elements described in the various examples are also included in the scope of the present disclosure.

The advantages and features of the present disclosure and the way of attaining them will become apparent with reference to examples described below in detail in conjunction with the accompanying drawings. Examples, however, may be embodied in many different forms and should not be constructed as being limited to example examples set forth herein. Rather, these examples are provided so that this disclosure will be complete and will fully convey the scope of the disclosure to those skilled in the art.

The term “module” or “unit” used in the specification means a software and/or hardware component, and the “module” or “unit” performs certain operations/functions/roles. However, the “module” or “unit” is not construed as being limited to software or hardware. The “module” or “unit” may be configured to be in an addressable storage medium or to execute one or more processors. Therefore, as an example, the “module” or “unit” may include at least one of components such as software components, object-oriented software components, class components, and task components, processes, functions, attributes, procedures, sub-routines, segments of program codes, drivers, firmware, micro-codes, circuits, data, databases, data structures, tables, arrays, or variables. Functions provided in the components, “modules”, or “units” may be combined into a smaller number of components, “modules”, or “units” or further divided into additional components, “modules”, or “units”.

In the present disclosure, the “module” or “unit” may be realized as a processor and a memory. The “processor” should be widely construed to include a general-purpose processor, a central processing unit (CPU), a microprocessor, a digital signal processor (DSP), a microcontroller, a state machine, or the like. In some environments, the “processor” may refer to an application-specific integrated circuit (ASIC), a programmable logic device (PLD), or a field-programmable gate array (FPGA), and the like. For example, the “processor” may refer to a combination of processing devices such as a combination of a DSP and a microprocessor, a combination of a plurality of microprocessors, a combination of one or more microprocessors combined with a DSP core, or any other such combination. Moreover, the “memory” should be widely construed to include any electronic component capable of storing electronic information. The “memory” may refer to various types of processor-readable medium such as a random access memory (RAM), a read only memory (ROM), a non-volatile random access memory (NVRAM), a programmable read only memory (PROM), an erasable programmable read only memory (EPROM), an electrically erasable programmable read only memory (EEPROM), a flash memory, a magnetic or optical data storage device, and registers. When the processor can read information from a memory and/or record the information in the memory, the memory may be in a state of electronic communication with a processor. Memory integrated into a processor is in a state of electronic communication with the processor.

The one or more features described herein may be provided as a computer program stored in a computer-readable recording medium in order to be executed on a computer. The medium may either continuously store a computer-executable program or temporarily store the program for execution or download. Furthermore, the medium may be a variety of recording or storage means in the form of a single hardware device or multiple combined hardware devices and is not limited to media directly connected to some computer system but may also be distributed across a network. Examples of such media include magnetic media such as a hard disk, a floppy disk, or a magnetic tape, optical recording media such as a CD-ROM or a DVD, magneto-optical media such as a floptical disk, and a ROM, RAM, or flash memory, among others, configured to store program instructions. Additional examples of such media include media or storage media that are managed by an app store that distributes applications or by various other sites or servers that provide or distribute software.

In a hardware implementation, processing units used for performing the techniques may be implemented within one or more ASICs, DSPs, digital signal processing devices, programmable logic devices, field-programmable gate arrays, processors, controllers, microcontrollers, microprocessors, electronic devices, or computers or combinations thereof designed to perform the functions described in the present disclosure.

For purposes of this application and the claims, using the exemplary phrase “at least one of: A; B; or C” or “at least one of A, B, or C,” the phrase means “at least one A, or at least one B, or at least one C, or any combination of at least one A, at least one B, and at least one C. Further, exemplary phrases, such as “A, B, or C”, “at least one of A, B, and C”, “at least one of A, B, or C”, etc. as used herein may mean each listed item or all possible combinations of the listed items. For example, “at least one of A or B” may refer to (1) at least one A; (2) at least one B; or (3) at least one A and at least one B.

In the present disclosure, expressions of location relations used in the present specification such as “upper”, “lower”, “left” and “right” are employed for the convenience of explanation, and in case drawings illustrated in the present specification are inversed, the location relations described in the specification may be inversely understood.

An automation level of an autonomous driving vehicle may be classified as follows, according to the American Society of Automotive Engineers (SAE). At autonomous driving level 0, the SAE classification standard may correspond to “no automation,” in which an autonomous driving system is temporarily involved in emergency situations (e.g., automatic emergency braking) and/or provides warnings only (e.g., blind spot warning, lane departure warning, etc.), and a driver is expected to operate the vehicle. At autonomous driving level 1, the SAE classification standard may correspond to “driver assistance,” in which the system performs some driving functions (e.g., steering, acceleration, brake, lane centering, adaptive cruise control, etc.) while the driver operates the vehicle in a normal operation section, and the driver is expected to determine an operation state and/or timing of the system, perform other driving functions, and cope with (e.g., resolve) emergency situations. At autonomous driving level 2, the SAE classification standard may correspond to “partial automation,” in which the system performs steering, acceleration, and/or braking under the supervision of the driver, and the driver is expected to determine an operation state and/or timing of the system, perform other driving functions, and cope with (e.g., resolve) emergency situations. At autonomous driving level 3, the SAE classification standard may correspond to “conditional automation,” in which the system drives the vehicle (e.g., performs driving functions such as steering, acceleration, and/or braking) under limited conditions but transfer driving control to the driver when the required conditions are not met, and the driver is expected to determine an operation state and/or timing of the system, and take over control in emergency situations but do not otherwise operate the vehicle (e.g., steer, accelerate, and/or brake). At autonomous driving level 4, the SAE classification standard may correspond to “high automation,” in which the system performs all driving functions, and the driver is expected to take control of the vehicle only in emergency situations. At autonomous driving level 5, the SAE classification standard may correspond to “full automation,” in which the system performs full driving functions without any aid from the driver including in emergency situations, and the driver is not expected to perform any driving functions other than determining the operating state of the system. Although the present disclosure may apply the SAE classification standard for autonomous driving classification, other classification methods and/or algorithms may be used in one or more configurations described herein.

One or more features associated with autonomous driving control may be activated based on a feature of road-boundary reconstruction using radar-based detection and image-assisted approximation. For example, when the reconstructed boundary indicates lane narrowing or roadside deviation (e.g., near a construction zone, tunnel entrance, or curved shoulder), the autonomous driving control may adjust steering or deceleration to maintain a safe offset from the boundary. In another example, when the reconstructed boundary data predicts a discontinuity or missing edge (e.g., due to heavy rain or occluded markings), the control system may temporarily lower the autonomous driving level and request driver intervention to ensure safe operation.

One or more auxiliary devices (e.g., engine brake, exhaust brake, hydraulic retarder, electric retarder, regenerative brake, etc.) may also be controlled based on a feature of road-boundary reconstruction using radar-based detection and image-assisted approximation. For example, when the reconstructed boundary indicates a narrowed or curved lane (e.g., near guardrails, roadside barriers, or tunnel walls), the regenerative brake may increase braking torque to maintain a safe lateral position. In another example, when the reconstructed boundary predicts an upcoming slope or shoulder drop-off (e.g., detected via radar-based terrain contouring), the engine brake or retarder may be preemptively adjusted to stabilize vehicle deceleration and reduce lateral drift risk.

One or more communication devices may also be controlled based on a feature of road-boundary reconstruction using radar-based detection and image-assisted approximation. For example, when the reconstructed boundary indicates degraded visibility or missing roadside structures (e.g., during fog, tunnel entry, or snow accumulation), the communication device may increase transmission frequency for vehicle-to-infrastructure (V2X) messages to obtain supplemental map or lane information. In another example, when the reconstructed boundary confidence is high, the system may temporarily reduce external data requests (e.g., from a cloud server or nearby vehicles) to save bandwidth and prioritize safety-critical communication.

Minimum risk maneuver (MRM) operation(s) may also be controlled based on a feature of road-boundary reconstruction using radar-based detection and image-assisted approximation. For example, when the reconstructed boundary indicates a lane edge discontinuity or roadside obstruction (e.g., a missing curb, cone, or guardrail), the MRM control may steer the vehicle toward a safe lateral zone within the detected boundary. In another example, when the reconstructed boundary confidence drops below a threshold (e.g., due to heavy rain or sensor occlusion), the vehicle may automatically reduce speed or stop within a verified lane area to reduce collision risk while maintaining a stable posture until driver takeover.

Biased driving operation(s) may also be controlled based on a feature of road-boundary reconstruction using radar-based detection and image-assisted approximation. For example, when the reconstructed boundary indicates that one side of the road lacks a clear edge (e.g., due to occlusion by parked vehicles, snow, or poor lighting), the driving control apparatus may bias the vehicle's lateral position away from that side to maintain a safer distance. In another example, when the reconstructed boundary reveals a temporary narrowing or roadside barrier (e.g., guardrail, cone, or curb), the vehicle may adjust the biased target lateral distance to prevent side collision while maintaining smooth lane-keeping control.

One or more sensors may also be controlled based on a feature of road-boundary reconstruction using radar-based detection and image-assisted approximation. For example, when the reconstructed boundary indicates lane narrowing or unclear edge conditions (e.g., due to occlusion, fog, or reflective interference), the radar or camera sensor parameters may be dynamically adjusted (e.g., increasing radar pulse rate or image exposure time) to improve boundary estimation accuracy. In another example, when the reconstructed boundary confidence exceeds a threshold, redundant sensing modules (e.g., side cameras or ultrasonic sensors) may be deactivated to reduce power consumption while maintaining reliable road-edge detection.

An autonomous driving level and/or autonomous driving activation or deactivation may be controlled based on a feature of road-boundary reconstruction using radar-based detection and image-assisted approximation. For example, when the reconstructed road boundary indicates a narrowed lane, a curved road, or a missing boundary segment (e.g., due to rain, occlusion, or low reflectivity), the autonomous driving level may be lowered, or manual driving may be temporarily requested. Conversely, when the reconstructed boundary is verified as continuous and reliable (e.g., by consistent radar-image fusion confidence values), a higher autonomous driving level may be maintained. In another example, if the system determines that boundary detection quality degrades beyond a threshold, autonomous driving may be deactivated, and a warning may be output to the driver via a display or audio alert. According to the present disclosure, a vehicle and method are provided for accurately processing a road boundary even when sensor data are incomplete. Radar sensors, while cost-effective, may produce sparse point cloud data leading to gaps in boundary estimation. To address this, a processor analyzes radar-based point cloud data to identify static objects such as guardrails, curbs, or cones that define a valid boundary and generates a virtual road boundary by extending the detected boundary. When an undetected area is determined, the processor determines whether the undetected area likely contains an undetected object and, if so, connects a missing section using static object data or past boundary information to form a final road boundary. Image-sensor data may also be fused to refine the boundary where radar data are limited. Thus, the present disclosure enables reliable and continuous road boundary determination, enhancing autonomous driving accuracy with reduced sensor cost.

Hereinafter, examples of the present disclosure will be described with reference to the accompanying drawings.

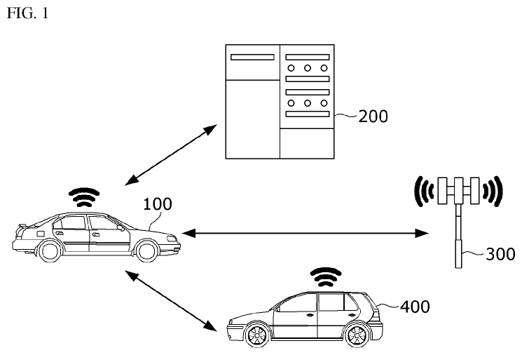

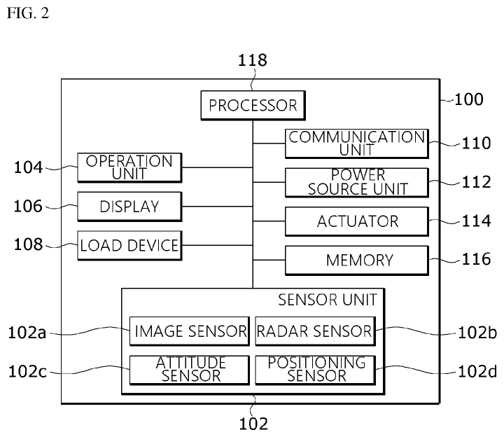

Hereinafter, a vehicle that processes a sensor track will be described with reference to FIGS. 1 to 3.

FIG. 1 shows an example that a vehicle communicates with another device to transmit and receive data.

Referring to FIG. 1, a vehicle 100 may be driven based on electric energy or fossil energy. In the case of electric energy, the vehicle 100 may employ, for example, a pure battery-based vehicle driven only by a high-voltage battery or a gas-based fuel cell as an energy source. In addition, the fuel cell may use various types of gas capable of generating electric energy (e.g., hydrogen, methane, ammonia, or biogas, etc.), and the gas may be filled into the vehicle 100 in a liquefied state, for example. Here, the gas may be hydrogen as an example. However, the gas is not limited thereto, and various gases may be applied. In the case of fossil energy, the vehicle 100 is driven by fuel such as gasoline, diesel, or liquefied gas, and may be equipped with an internal combustion engine that drives an actuator 114 by combustion of the fuel. The engine may be included in a power source unit 112 from the viewpoint of providing a driving rotational force of a wheel. As another example, the vehicle 100 may drive the actuator 114 by selectively utilizing the energy of the fossil energy-based internal combustion engine and the electric battery, which may be a hybrid type vehicle (e.g., a plug-in hybrid, a mild hybrid, or a series hybrid, etc.).

The vehicle 100 may refer to a moveable device. The vehicle 100 is a ground vehicle that drives on the ground and may be a conventional passenger or commercial vehicle, a Purpose Built Vehicle (PBV), or the like. The vehicle 100 may be a four-wheeled vehicle, such as a passenger car, an SUV, a small truck, or may be a vehicle with more than four wheels, such as a bus, a large truck, a container carrying vehicle, a heavy-equipment vehicle (e.g., a forklift, a dump truck, or a construction crane, etc.), and the like. The vehicle 100 may be a robot in a broad sense, such as a moving means, and the robot may be moved using wheels, tracks, or other moving modules (e.g., caterpillar tracks, omni-directional wheels, or leg-type actuators, etc.).

The vehicle 100 may be controlled to be driven by manual driving or autonomous driving due to the driving of a user. The autonomous driving may be implemented as semi-autonomous driving or fully autonomous driving. The fully autonomous driving may be provided as autonomous driving in which a processor 118 of the vehicle 100 completely controls without user intervention even when the driving situation is uncertain (e.g., complex urban intersections, unexpected pedestrian crossings, or tunnel entry conditions, etc.). The semi-autonomy driving may be provided by autonomous driving in which driver intervention is required according to a specific driving situation (e.g., adverse weather, road construction zones, or sensor degradation, etc.). The semi-self-driving may be implemented such that the processor 118 switches the control to the user while deactivating the autonomous driving when the above situation occurs, thereby causing the user to perform manual driving. According to the level of autonomous driving defined by the American Society of Automotive Engineers (SAE), the semi-autonomous driving may correspond to the autonomous driving levels 1 to 4, and the fully autonomous driving may correspond to level 5.

The vehicle 100 may communicate with other devices 200 and 300 or another vehicle 400. The other devices may include, for example, a server 200 that supports various controls, state management, and driving of the vehicle 100, an intelligent transportation system (ITS) device 300 for receiving information from the ITS, various types of user devices, and the like (e.g., smartphones, wearable devices, or in-vehicle infotainment terminals, etc.). The server 200 is, for example, an external device operated by a vehicle manufacturer or provided for servicing a driving support function and may receive connected data of the vehicle 100 or transmit data necessary for manual and autonomous driving. The server 200 may transmit various information and software modules used for controlling the vehicle 100 to the vehicle 100 in response to requests and data transmitted from the vehicle 100 and a user device, so as to support driving and various services of the vehicle 100 (e.g., navigation updates, remote diagnostics, or over-the-air firmware upgrades, etc.).

The ITS device 300 is, for example, a Roadside Base Station (RSU), and the ITS device 300 may mutually exchange vehicle recognition data, driving control and state data, environmental data around the vehicle, map data, and the like via V2I with the vehicle 100 to assist the user in driving the own vehicle or support autonomous driving of the vehicle 100 (e.g., by providing traffic light status, construction alerts, or real-time congestion information, etc.). The vehicle 100 may mutually exchange the above-listed data via V2V with the other vehicle 400 to support manual driving or autonomous driving (e.g., for collision avoidance, cooperative lane merging, or platooning, etc.).

The vehicle 100 may communicate with other vehicles or other devices based on cellular communication, Wireless Access in Vehicular Environment (WAVE) communication, Dedicated Short Range Communication (DSRC) or near field communication, or other communication schemes (e.g., Wi-Fi Direct, Bluetooth, or ultra-wideband communication, etc.).

For example, the vehicle 100 may use as a cellular communication network such as a communication network such as LTE or 5G, a WiFi communication network, a WAVE communication network (e.g., IEEE 802.11p or IEEE 802.11bd) for communication with the server 200, the ITS device 300, and the other vehicle 400. For another example, a DSRC or the like used in the vehicle 100 may also be used for communication between vehicles. A communication manner between the vehicle 100, the server 200, the ITS device 300 and another vehicle 400, or a user device may include any combination of wired or wireless schemes (e.g., optical cable, millimeter-wave link, or satellite relay, etc.) and is not limited to the foregoing example.

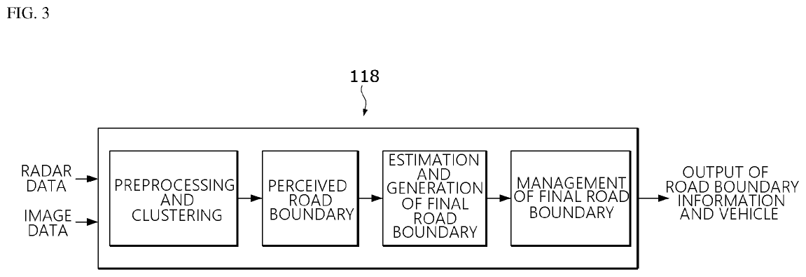

FIG. 2 shows exemplary modules that constitute the vehicle according to an example of the present disclosure.

The vehicle 100 may include a sensor unit 102, an operation unit 104, a display 106, a load device 108, and a communication unit 110.

The sensor unit 102 may include various types of sensors for sensing various states and situations occurring in the external surrounding environment, internal systems, user operation, and boarding space of the vehicle 100 (e.g., road conditions, nearby objects, driver posture, or cabin temperature, etc.).

Specifically, the sensor unit 102 may include an externally oriented image sensor 102a, a radar sensor 102b, and the like so as to recognize dynamic and static objects existing around the vehicle 100 (e.g., pedestrians, vehicles, traffic signs, or curbs, etc.).

The image sensor 102a may generate image data by recognizing an external object as an image during use of the vehicle 100 and transmit the image data to the processor 118. The image sensor 102a may be referred to as a first sensor in the present disclosure. At least one image sensor 102a may be mounted on a specific site of the vehicle 100 such as a front site, a rear site, or a side site of the vehicle 100 (e.g., a front-view camera, a rear-view camera, or a side-surround-view camera, etc.). When a plurality of image sensors 102a are mounted on each site, it may be referred to a multi camera in the present disclosure. Image data obtained by the plurality of image sensors 122a may be referred to multi-view image data (e.g., panoramic view, bird's-eye view, or 360-degree surround view, etc.). Although not shown, the sensor unit 102 may further include a camera facing an interior of the vehicle 100 (e.g., a driver monitoring camera or a passenger detection camera, etc.).

The radar sensor 102b may emit radio waves of a specific frequency around the vehicle 100 to generate radar data via the radio waves reflected from an external object, so as to grasp the presence and relative distance, speed, direction, and the like of the external object (e.g., other vehicles, barriers, guardrails, or cyclists, etc.). The radar sensor 102b may be referred to as a second sensor in the present disclosure. In addition, the radar sensor 102b in the present disclosure may be a kind of heterogeneous sensor different from the image sensor 102a, by recognizing an object in a different manner from the image sensor 102a (e.g., by detecting radio-wave reflection intensity or Doppler shift, etc.).

In the present disclosure, it is illustrated that a lidar sensor (not shown) is not mounted, but in another example, the lidar sensor may be mounted on the vehicle 100. The lidar sensor may generate point cloud data as recognized data of an external object and transmit the point cloud data to the processor in order to generate three-dimensional spatial information identifying at least a shape of the external object (e.g., buildings, road boundaries, or traffic cones, etc.). The lidar sensor may be a type of heterogeneous sensor different from the image sensor 102a.

The sensor unit 102 may include an attitude sensor 102c. The attitude sensor 102c may detect, for example, states of three axes of the vehicle 100, such as yaw, pitch, and roll, and output various posture states of the vehicle based on the above-described factors (e.g., tilting on a slope, turning motion, or body vibration, etc.). The attitude sensor may include, for example, an IMU sensor, a gyro sensor, and the like (e.g., an accelerometer or magnetometer, etc.). The processor 118 may generate posture data based on the posture states.

In addition, the sensor unit 102 may include a positioning sensor 102d for confirming the position of the vehicle 100. The positioning sensor 102c is, for example, but not limited to, a GPS sensor or a GNSS sensor (e.g., GLONASS, Galileo, or BeiDou, etc.).

In addition, although not shown in FIG. 1, the sensor unit 102 may include a brake sensor and a wheel sensor. The brake sensor detects a braking degree of a brake (e.g., brake pressure, pedal stroke, or pad temperature, etc.), and the wheel sensor may detect, for example, a wheel speed, a wheel rotation angle, and a wheel rotation angular speed of a wheel (e.g., using Hall sensors, optical encoders, or magnetoresistive sensors, etc.). The present disclosure mainly describes the sensors of the sensor unit 102 referred to in the description of the example, and may further include sensors that sense various situations not listed here (e.g., rain sensors, temperature sensors, ultrasonic sensors, or tire-pressure sensors, etc.).

The operation unit 104 may be configured as a module for a user to control for driving. For example, the operation unit 104 may include a steering wheel for manual driving, an automatic or manual transmission actuator, an accelerator pedal, a brake pedal, a gear transmission, or the like (e.g., a joystick-type control, paddle shifters, or touch-based drive selector, etc.). The operation unit 104 further includes an interface for use, release, and selection of detailed functions of an autonomous driving mode requested by the user, so that the user uses the autonomous driving function (e.g., lane-keeping mode, adaptive cruise control, or auto-parking, etc.). The operation unit 102 may be configured as, for example, a hard-type interface provided at a predetermined position inside the vehicle 100 or a soft-type interface touchable on the display 106, so as to receive various requests related to autonomous driving.

The display 106 may function as a user interface. The display 106 may display, by the processor 118, an operation state of the vehicle 100, a control state, path/traffic information, remaining energy information, content requested by a driver, and the like to be output (e.g., navigation maps, sensor visualization, or infotainment content, etc.). In addition, the display 106 may be configured as a touch screen capable of detecting driver input and may receive a request of the driver instructing the processor 118 (e.g., route selection, destination entry, or system setting adjustments, etc.).

The communication unit 110 may support mutual communication with the server 200, the ITS device 300, the surrounding vehicle 400, and the like (e.g., via V2V, V2I, or V2X communication, etc.). For example, the communication unit 110 may include a module that processes cellular communication, WAVE, DSRC communication, and the like, In the present disclosure, the transmission/reception unit 116 may transmit data generated or stored during driving to the server 200 in the form of a signal, and receive data and a software module transmitted from the server 200 in a specific type of signal (e.g., an over-the-air update, map data, or diagnostic code, etc.).

The communication unit 110 may support communication for transmitting or receiving signals related to data, control, commands, and requests between the components in FIG. 2 (e.g., between the processor 118, the operation unit 104, or the sensor unit 102, etc.). The components may be devices or modules referred to as reference numerals 102 to 118 illustrated in FIG. 2, for example. The communication unit 110 transfers signals transmitted between the components, for example, signals related to data, control, commands, and requests, to a communication bus by using Controller Area Network (CAN) communication, for example, and may transmit the signals to a specific component. Data, control, command, and requests transferred through CAN communication may be referred to as CAN data (e.g., steering commands, braking requests, or sensor fusion data, etc.).

The communication unit 110 may support communication with an electronic device carried by a passenger inside the vehicle 100 (e.g., smartphone pairing, wearable synchronization, or wireless charging handshake, etc.). In the present disclosure, the vehicle 100 may transmit and receive data utilized in the method according to the present disclosure to and from the outside via the communication unit 110.

The vehicle 100 may also include a power source unit 112 and an actuator 114.

The power source unit 112 may generate and supply power and electric power to be used for a driving power system and a non-driving power system, such as the actuator 114. The non-driving power system may be, for example, the sensor unit 102, the operation unit 104, the display 106, the load device 108, the communication unit 110, and the like, and is not limited thereto, and may include various components that implement sensing, interface, communication, and convenience functions (e.g., lighting, HVAC, or infotainment systems, etc.) except for components directly involved in a driving operation.

When the vehicle 100 is driven on an electric energy basis, the power source unit 112, for example, may be an electric battery that is charged from the outside, or may be configured with a combination of an electric battery and a fuel cell that charges the battery (e.g., a lithium-ion battery combined with a hydrogen fuel cell, etc.). In the case of a combination of the electric battery and the fuel cell, the power source unit 112 may include a tank that stores a material used to generate electric power of the fuel cell, such as liquefied hydrogen (e.g., in a cryogenic or high-pressure form, etc.). When the vehicle 100 may be driven on a fossil energy basis, the power source unit 112 may include an internal combustion engine. Further, when the vehicle 100 is of a hybrid type, the power source unit 112 may be provided by a combination of the internal combustion engine and the electric battery (e.g., a parallel hybrid or a series-parallel hybrid configuration, etc.).

The actuator 114 includes at least one module that implements a driving operation and may execute the driving operation based on a user request from the operation unit 104 or a signal according to a request of the processor 118. The signal according to the request may be related to at least one of longitudinal control such as acceleration and deceleration, transverse control such as steering, and gear shift, for example (e.g., throttle control, regenerative braking, or automatic gear change, etc.). Here, the gear shift may be processed by a request of a manual driving user using a gear transmission or the processor 118 in autonomous driving.

The actuator 114 may include a wheel driving unit, a mechanical component and an electronic module for implementing a driving operation on the wheel driving unit, so as to implement a driving operation depending on a command of the processor 118 by a user's manual operation or autonomous driving (e.g., electronic throttle, electric steering, or brake-by-wire module, etc.). When the vehicle 100 is operated based on electric energy, it may include an assembly for transmitting a requested driving operation to the wheel driving unit. When the vehicle is operated based on fossil energy, the actuator 114 may include a transmission and a gear module for transmitting power of an internal combustion engine (e.g., a torque converter, clutch pack, or multi-gear automatic transmission, etc.).

The wheel driving unit may include a plurality of wheels, a driving force generation module for generating a driving force and applying it to the wheels or transmitting the driving force, a braking module for decelerating driving of the wheels, and a steering module for realizing transverse control of the wheels (e.g., rack-and-pinion, steer-by-wire, or rear-wheel steering, etc.). When the vehicle 100 is driven based on electric energy, the driving force generation module may be configured as a motor assembly that generates a driving force based on power output from an electric battery (e.g., an induction motor, a permanent-magnet motor, or an in-wheel motor, etc.). When the vehicle is driven based on fossil energy, the driving power generation module may be an engine or a transmission assembly. The braking module of the electric-based vehicle 100 may further have a regenerative braking function (e.g., converting kinetic energy to charge the battery during deceleration, etc.).

The vehicle 100 may also include a memory 116 and the processor 118.

The memory 116 may store an application and various data for control of the vehicle 100 to load the application or read and write the data at the request of the processor 118. In the present disclosure, the memory 116 may include an example according to the present disclosure, i.e., an application that tracks radar object data associated with objects detected from the radar sensor 102b and processes road boundaries from the data (e.g., to identify lane edges, guardrails, or curbs, etc.).

The radar object data may include an area based on point cloud data obtained by the radar sensor 102b. The area may be provided to have a boundary surrounding an object identified from the point cloud data (e.g., a vehicle, a wall, or a traffic barrier, etc.). A track is included in track information, and in the present disclosure, the track information may be interchangeably described with radar track information to distinguish it from other terms. The radar track information may include, for example, a track area, a track identifier, a position of an object, a speed of the object, an orientation angle of the object, a type (or class) of the object and a reliability of the object estimation, a number of times the track is maintained (e.g., a persistence value, history index, or frame count, etc.).

The application may include processing of performing specific processing on point cloud data to generate a new radar track, and predicting a state of an object based on radar track information of a preceding radar track that has been previously generated (e.g., using Kalman filtering, particle filtering, or motion extrapolation, etc.). In addition, the application may include processing for determining a position of the new radar track, specifically, an object on which the radar track is located. The application may generate a perceived road boundary from a static object identified as a road boundary among static objects perceived by the radar sensor 102b (e.g., a curb, guardrail, or lane-side fence, etc.).

The application may, for example, generate a final road boundary by estimating the shape of the final road boundary according to an analysis between the perceived road boundary and a static object perceived to be spaced apart from the perceived road boundary by the radar sensor 102b (e.g., where a curb segment ends but a guardrail continues, etc.). As another example, the application may generate a final road boundary by estimating the shapes of the final road boundary according to analysis between a preceding final road boundary and a spaced apart static object. The preceding final road boundary may be estimated based on point cloud data obtained at a preceding time (or preceded) by the radar sensor 102b. Details of the estimation and generation described above will be described below.

The application may include a process of associating tracks by identifying an identity between a new radar track and an existing track, using a result of the prediction process and an association condition between the tracks (e.g., distance threshold, velocity similarity, or angular alignment, etc.). Further, the application may include a processing of newly assigning a track identifier, or maintaining or deleting a track, according to a result of the association process (e.g., removing lost tracks, merging overlapping ones, or updating IDs for persistent targets, etc.). The generated final road boundary may be managed every acquisition period of radar data in the radar sensor 102b, for example, every scan period (e.g., every 50 ms, 100 ms, or 200 ms, etc.). The management may include maintaining, deleting, changing, and the like of the final road boundary.

In addition, the application may include a process of fusing the image object data detected from the image sensor 104a with the radar object data during the association process (e.g., fusing bounding boxes, depth estimates, or object classifications, etc.). The fused object data, i.e., the fused track, may be used for the association process, and the track information used for managing the track information may be provided based on the fused track.

The processor 118 may perform overall control of the vehicle 100. The processor 118 may be configured to execute an application and an instruction stored in the memory 116. The processor 118 may generate, depending on a driving control request in manual driving and autonomous driving, a signal related to control for a component of the vehicle 100, The component may be at least one of various members described in FIG. 2. The processor 118 may include, for example, at least one of a central processing unit (CPU), a graphical processing unit (GPU), and a neural processing unit (NPU) (e.g., for real-time perception, object recognition, or control optimization, etc.). The processor 118 may function as a controller in another example. The controller includes the above processing unit, a cache memory, a bus interface, and the like, and may be, for example, an electric control unit (ECU).

The processor 118 may execute various processes for generating and managing road boundaries based on point cloud data in accordance with the present disclosure (e.g., segmentation, clustering, or regression-based boundary extension, etc.). The point cloud data may be described herein as being obtained from the radar sensor 102b. However, unless technically contradictory, examples of the present disclosure may also be applied to point cloud data obtained from a lidar sensor (e.g., for higher-resolution or redundancy-based detection, etc.).

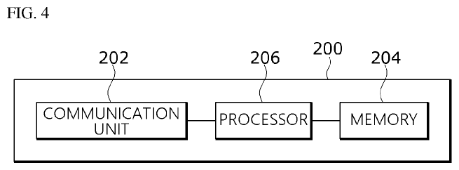

Referring to FIG. 3, the processor 118 that processes generation and management of a road boundary using sensor data obtained from the radar sensor 102b will be described. FIG. 3 shows an example of generation and management of a road boundary based on sensor data.

The processor 118 of the vehicle 100 may perform preprocessing of radar data acquired from the radar sensor 102b (e.g., point cloud data filtering, clustering of the data, or feature extraction, etc.). Here, the radar data is exemplified as point cloud data, but the preprocessing may include, for example, filtering to remove noise and outliers in point cloud data, time alignment, spatial transformation of the track identified by clustering of the filtered point cloud data, synchronization with other sensor data, and the like (e.g., Kalman-based smoothing, ground removal, or DBSCAN clustering, etc.). The spatial transformation may include, for instance, transforming the spatial data (e.g., coordinates) of the track from a radar sensor coordinate system (e.g., polar coordinates relative to the radar sensor) to a coordinate system of a given perspective (e.g. world space system or vehicle-fixed frame, etc.).

The clustering may include clustering the point cloud data to generate radar tracks based on a distribution state of the point cloud data and statistical data related to the distribution, and generating radar track information for each radar track (e.g., track ID, centroid, or covariance, etc.). The radar tracks may be generated to represent an object estimated from the point cloud data (e.g., a guardrail segment, a vehicle, or a traffic cone, etc.).

The processor 118 may generate a perceived road boundary (e.g., a detected road boundary) based on a static object identified as road boundaries among the radar tracks (e.g., curb edges, guardrails, or lane-side barriers, etc.).

The radar track may include static objects and dynamic objects perceived around the vehicle 100. The static objects may include, for example, road facility objects including traffic markers displayed on the road and road structures installed on/around the road. Road structures may be installed to have a certain physical form on the roadway, as opposed to traffic markers printed on the roadway (e.g., curbs, bollards, or barriers, etc.). The dynamic objects may include, for example, other vehicles, cyclists, animals, pedestrians, scooters, etc., around vehicle 100.

The traffic markers may include, for example, lanes, speed limits, arrows, driving direction indicators, or stop lines, etc. The road structures may include, for instance, road boundaries, road signs, guardrails, traffic cones, traffic rods, anti-collision barriers, or curbs, etc. The road boundaries may be, for instance, objects representing road boundaries for distinguishing road areas from non-road areas or objects serving as lanes for distinguishing lanes (e.g., raised curbs, painted edge lines, or concrete dividers, etc.). Road structures used as road boundaries may be, for examples, guardrails. cones, rods, barriers, curbs, etc.

Accordingly, the processor 118 may generate a perceived road boundary (e.g., a detected road boundary) based on tracks identified as road boundaries in tracks associated with road structures on the road.

The processor 118 may execute a process of generating a virtual road boundary based on a valid road boundary including at least a perceived road boundary (e.g., extending a detected road boundary using regression line information). The processor 118 may perform a process of determining whether to adopt a static object as a boundary candidate based on approximation of the virtual road boundary and a static object perceived by the radar sensor 102b (or the first sensor) to be spaced apart from the valid road boundary. Based on the static object being adopted as a boundary candidate, the processor 118 may determine whether an unperceived area of the radar sensor 102b between the perceived road boundary on the valid road boundary and the boundary candidate is estimated to be in a presence-non-detection state. The presence-non-detection state may refer to a state in which an object undetected by the radar sensor 102b is estimated to be present in the surrounding environment (e.g., due to occlusion, low reflectivity, or grazing incidence, etc.). The presence-non-detection state may be referred to as a false-negative state in the present disclosure. Based on the unperceived area being estimated to be in the presence-non-detection state, the processor 118 may execute a process for estimating (or generating) a final road boundary based on the perceived road boundary and the static object (e.g., by connecting the detected boundary and a boundary line associated with the static object). The generated final road boundary may be included in road boundary information (e.g., with a timestamp, confidence, or version ID, etc.) including the track information described above.

With respect to dynamic objects, the processor 118 may include processing to predict a state of the object based on radar track information of a previously generated preceding radar track (e.g., constant-velocity or constant-turn-rate prediction, etc.). In addition, the processor 118 may update the prediction state. Specifically, the processor 118 may correct the prediction state using actual measurements or detections obtained from the radar sensor 102b, for example (e.g., via measurement updates or gating tests, etc.).

The processor 118 may execute a process of interactive associating a preceding final road boundary estimated from a preceding track and a final road boundary generated in a new track to determine an identity between the preceding and the new tracks (e.g., using overlap ratio, Hausdorff distance, or ICP-based alignment, etc.). Here, the final road boundary may refer to road boundary information. The association process may also be performed in a track associated with a dynamic object (e.g., vehicle-to-vehicle track continuity, etc.).

The processor 118 may include a process of newly assigning a track identifier, or maintaining or deleting a track, depending on a result of the association process (e.g., create, update, or delete operations, etc.). For example, the processor 118 may manage road boundary information related to a final road boundary (e.g., persistence, aging, or conflict resolution, etc.). When a track is maintained, track information of an associated track may be reflected in an existing track and updated. When a target object disappears from an area of interest of the sensor unit 102, and a specific track does not match track information of an existing track for a period of time, the existing track may be deleted (e.g., after N consecutive misses exceeding a timeout, etc.).

The processor 118 may control the vehicle 100 based on the track information including the road boundary information and the dynamic object (e.g., lane keeping, collision avoidance, or path replanning, etc.). For example, the processor 118 may control the autonomous driving of the vehicle 100 based on the road boundary information. In detail, the processor 118 may establish a driving path based on the road boundary information and control the actuator 114 based on a control signal based on the driving path (e.g., steering angle, longitudinal acceleration, or gear selection, etc.).

In another example, image data utilized in track positioning determination may also be utilized for association and track information management. The processor 118 may, in association processing, fuse image tracks and new radar tracks recognized in the image data into a common space, associate the image and radar tracks in the common space, and output fused track information (e.g., by extrinsic calibration and projection to a shared coordinate frame, etc.). The image tracks and radar tracks may, for example, include a perceived road boundary. Fusion may be performed through matching of objects detected at each sensor 102a and 102b, association/projection of matched objects using geometric parameters of each sensor 102a and 102b, and calibration of both track information (e.g., using reprojection error, bundle adjustment, or synchronization stamps, etc.). The fused track information may include at least substantially the same data as the radar track information. The processor 118 may use the fused track information to manage track information and control the vehicle 100, for example, actuator 114, based on the fused track data.

The processor 118 is illustrated in the present disclosure as being configured as a single processing module. In another example, the processor 118 may be distributed to a plurality of processing modules, and the above processing may be executed by a distributed processing model (e.g., domain controllers, edge ECUs, or centralized compute, etc.).

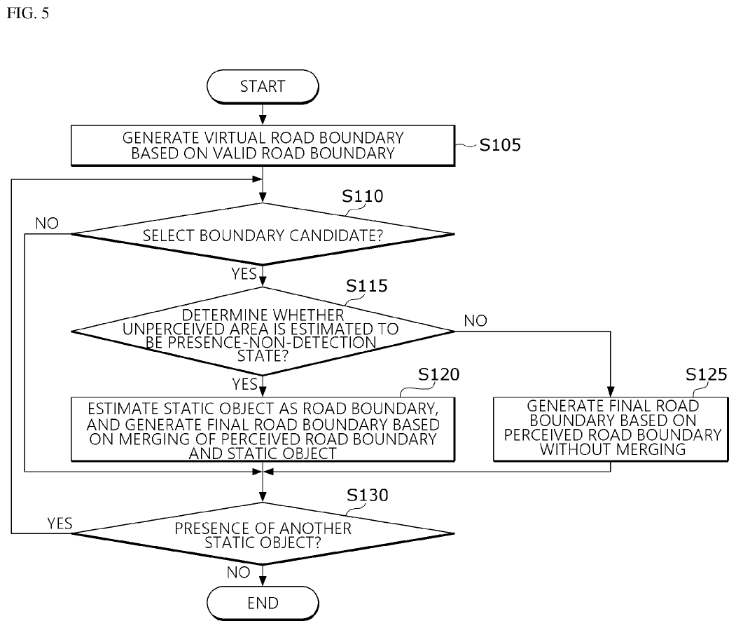

FIG. 4 shows exemplary modules that constitute a server according to the present disclosure.

The server 200 may transmit response data depending on a request of the vehicle 100 to the vehicle 100, and may transmit an application built in the vehicle 100 and information for supporting vehicle driving to the vehicle 100 (e.g., navigation map data, real-time traffic information, or remote control instructions, etc.). The server 200 may include a communication unit 202, a memory 204, and a processor 206.

The communication unit 202 may transmit and receive data to and from an external device, supports mutual communication with the vehicle 100 in the present disclosure, and may exchange data with the vehicle 100 (e.g., vehicle status reports, diagnostic data, or over-the-air software updates, etc.).

The memory 204 may store an application for operating the server 200 and various data and load the application or read and write the data according to a request of the processor 206. In the present disclosure, the memory 204 may manage data and software related to a model for processing a sensor track embedded in the vehicle 100, for example, a track based on the radar sensor 102b (e.g., object-classification weights, regression coefficients, or neural-network parameters, etc.).

The processor 206 may perform overall control of the server 200. The server 200 may be configured to execute an application and instructions stored in the memory 204. The processor 206 executes the application to process and respond to a user's request transmitted from the vehicle 100 (e.g., data synchronization, service authentication, or fleet-level analysis, etc.).

The processor 206 is illustrated in the present disclosure as being configured as a single processing module. In another example, the processor 206 may be distributed to a plurality of processing modules, and the above processing may be executed by a distributed processing model (e.g., cloud computing clusters, edge gateways, or hybrid edge-cloud architecture, etc.).

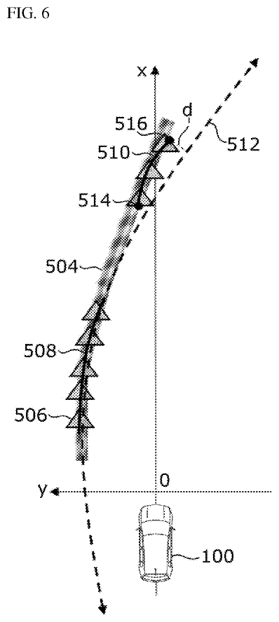

Hereinafter, a method of processing a road boundary according to another example of the present disclosure will be described in detail with reference to FIG. 5. FIG. 5 shows an exemplary method for processing a road boundary according to another example of the present disclosure. The method described in FIG. 5 may perform processing related to estimation and generation of the final road boundary of FIG. 3 (e.g., extrapolation, fusion, or temporal consistency updates, etc.).

The method of the present disclosure is performed by the processor 118, but for convenience of description, the processor 118 and the vehicle 100 may be described interchangeably. Although a sensor that generates point cloud data is described in the present disclosure as being the radar sensor 102b, the processing of a road boundary based on point cloud data by the lidar sensor may also use examples according to the present disclosure, as long as there is no technical contradiction (e.g., higher-density lidar data used for redundancy or validation, etc.).

Referring to S105 of FIG. 5, the processor 118 may generate a virtual road boundary based on a valid road boundary generated from point cloud data of a first sensor that detects the surrounding environment of the vehicle 100. The first sensor is the radar sensor 102b in the present disclosure, and for convenience of description, the first sensor may be described as being the radar sensor 102b.

The radar sensor 102b may generate point cloud data for detecting a static object and a dynamic object (e.g., vehicles, curbs, barriers, or guardrails, etc.). Hereinafter, a point in which radar object data related to the radar sensor 102b is a static object will be mainly described. Radar object data related to a dynamic object are described with reference to FIGS. 1 to 3, and processing thereof will be omitted.

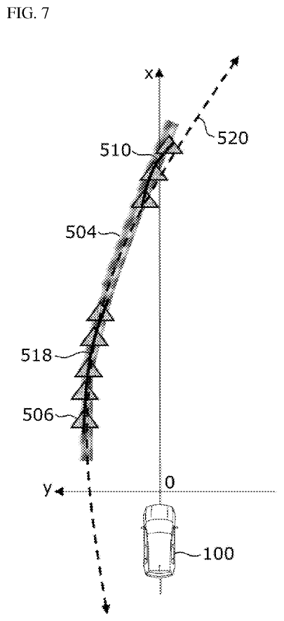

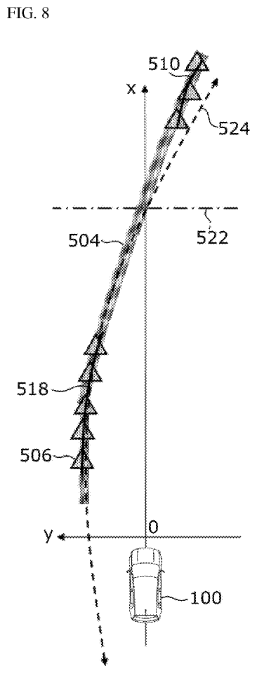

The static object may be, for example, a road structure that is installed in a predetermined physical form on a road and is spatially distinct from the road (e.g., a curb, cone, or fence, etc.). In addition to the road structure, the static object may include various objects that are fixed on the road and have a physical form (e.g., light poles, signposts, or delineators, etc.). The processor 118 may identify a road boundary by an object detection model based on point cloud data related to the road structure. The object detection model may be, for instance, a model based on machine learning or deep learning (e.g., convolutional neural networks, support-vector machines, or point-based segmentation models, etc.), and may identify a road boundary object (see 504 in FIG. 6) based on a track related to the road structure. The road boundary object 504 may be, for example, a guardrail, a cone, a rod, a barrier, a curb, or a line-divider, etc., and the road boundary object 504 is illustrated as a guardrail in FIG. 6.

The processor 118 may generate a perceived road boundary based on the road boundary object 504 detected and validly identified by the radar sensor 102b. The perceived road boundary may refer to a road boundary validly identified from point cloud data (e.g., after thresholding or regression fitting, etc.). For example, the processor 118 may generate a perceived road boundary 508 to have regression line information, as illustrated in FIG. 6. FIG. 6 shows an example of a virtual road boundary. The regression line information may be information describing a line of the perceived road boundary 508 estimated based on the point cloud data 506. For example, regression line information may have an equation describing a line passing through the point cloud data 506 by regression analysis on the point cloud data 506 (e.g., linear, quadratic, or piecewise polynomial, etc.). The equation may be, for example, a quadratic polynomial. The perceived road boundary is generated to have a line of finite length and may include point information of points at both ends of the line (e.g., start and end coordinates, slope, and intercept, etc.). The point information may include coordinates of the points at both ends according to the equation of the regression line information on a two-dimensional space, as illustrated in the FIG. 6.

As illustrated in FIG. 6, the processor 118 may generate an estimated boundary line 510 based on point cloud data of a static object perceived to be away from the perceived road boundary 508 (e.g., another curb segment or roadside barrier, etc.). The static object may be a road boundary object 504 or an object that is not a road boundary. Accordingly, the processor 118 may identify a road boundary or another object based on the static object. In the present disclosure, according to the above-described perspective, the static object away from the perceived road boundary 508 may be described without being limited to a specific type of object. The estimated boundary line 510 is generated to have regression line information and point information, identical to the perceived road boundary 508, and a detailed description of the regression line information and the point information in the estimated boundary line 510 will be omitted.

The processor 118 may determine a valid road boundary based on at least the perceived road boundary 508. Specifically, the processor 118 may determine a valid road boundary to include at least one of the at least perceived road boundary 508 (e.g., previously generated in a prior scan frame, etc.) and a preceding final road boundary. The preceding final road boundary may be a final road boundary generated in step S120 or S125 of FIG. 5. Here, “preceding” may mean a preceding time before a time at which the radar sensor 102b obtains point cloud data in step S105. Accordingly, a preceding final road step may be generated based on point cloud data obtained at a preceding time before a scan timing of the radar sensor 102b related to step S105. The preceding final road boundary is generated to have regression line information and point information, identical to the perceived road boundary 508, and a detailed description of this information will be omitted. Hereinafter, for convenience of description, the reference numeral 508 indicating the perceived road boundary in FIG. 6 may be referred to as a valid road boundary. The reference numeral 508 may also be referred to as a valid road boundary in other drawings other than FIG. 6.

The processor 118 may use regression line information based on the valid road boundary 508 to generate a virtual road boundary 512 that extends from the valid road boundary 508, as illustrated in FIG. 6 (e.g., for predicting unobserved portions or occluded road edges, etc.). The virtual road boundary 512 may extend from points at both ends of the finite valid road boundary 508 and be provided on a two-dimensional space. The virtual road boundary 512 may be generated to have the same regression line information as the valid road boundary 508 (e.g., sharing slope, curvature, and directionality parameters, etc.).

FIG. 7 shows an example of the virtual road boundary.

The processor 118 may generate a first virtual road boundary based on a first valid road boundary with sensor data of a first sensor, as well as generate a second virtual road boundary based on a second valid road boundary with sensor data of a second sensor (e.g., radar-image fusion for multi-sensor road-edge prediction, etc.). The first sensor and the second sensor may be the radar sensor 102b and the image sensor 102a, respectively, and each of the sensor data may be point cloud data and image data (e.g., radar reflectivity maps and lane-edge pixel maps, etc.). In FIG. 7, only the second virtual road boundary 520 is shown, and the first virtual road boundary is not shown. The first virtual road boundary may be the virtual road boundary 512 shown in FIG. 6, and the virtual road boundary of FIG. 6 may be provided in the two-dimensional space illustrated in FIG. 7 with the second virtual road boundary 520 to form the first virtual road boundary 512 (e.g., a composite lane-edge representation such as left-right road edges, inner-outer boundaries, or divided-lane segments, etc.). Accordingly, the virtual road boundaries may be generated to include the first virtual road boundary 512 and the second virtual road boundary 520. The first virtual road boundary 512 may be generated based on a first valid road boundary 508 including at least one of the at least perceived road boundary 508 and the preceding final road boundary, as described in FIG. 6.

With respect to the generation of the second virtual road boundary 520, the processor 118 may generate a perceived road boundary 518 based on the road boundary object 504 detected and validly identified by the image sensor 102a (e.g., by edge extraction, lane marking detection, or boundary segmentation, etc.). The perceived road boundary 518 may refer to a road boundary validly identified from the image data. For example, the processor 118 may generate the perceived road boundary 518 to have regression line information, as illustrated in FIG. 7 (e.g., slope, curvature, and offset parameters, etc.). The regression line information may be information describing a line of the perceived road boundary 518 estimated based on the image data. For example, the regression line information may have an equation describing a line approximating a road boundary object by regression analysis on the road boundary object 504 perceived in the image data (e.g., least-squares fit, RANSAC fitting, or polynomial regression, etc.). The equation may be, for example, a quadratic polynomial. The perceived road boundary 518 is generated to have a line of finite length and may include point information of points at both ends of the line (e.g., starting and ending coordinates or bounding pixel pairs, etc.). The point information may include coordinates of the points at both ends according to the equation of the regression line information on a two-dimensional space, as illustrated in the FIG. 7.

The processor 118 may determine a second valid road boundary based on the perceived road boundary 518. In the following, for convenience of description, reference numeral 518 may be referred to as a second valid road boundary. The processor 118, as illustrated in FIG. 7, may use regression line information based on the second valid road boundary 518 to generate a second virtual road boundary 520 that extends from the second valid road boundary 518 (e.g., into an extrapolated or occluded region beyond the camera's view, etc.). The second virtual road boundary 520 may be extended from points at both ends of the finite second valid road boundary 518 and provided on a two-dimensional space. The second virtual roads boundary 520 may be generated to have the same regression line information as the second valid road boundary 518 (e.g., identical slope, curvature, and confidence weighting, etc.).

According to the present disclosure, the first virtual road boundary 512 is generated based on the first valid road boundary 512 based on the sparse point cloud data (e.g., low-density radar reflections or coarse object contours, etc.), and boundary estimation close to the road boundary object 504 may not be guaranteed. Image object data related to the road boundary object 504 detected by the image data may realize boundary estimation close to the road boundary object 504 (e.g., fine-pixel-level edge delineation or lane-line curvature refinement, etc.). The second virtual road boundary 520 may have a higher boundary estimation characteristic than the first virtual road boundary 512, for example, due to higher spatial resolution or visual semantic accuracy.

FIG. shows an example of the virtual road boundary.

The second virtual road boundary 524 may be generated to extend to a detection range of a first sensor (e.g., the radar sensor 102b) that is greater than a detection range 522 of a second sensor (e. g., the image sensor 102a) (e.g., radar range≈200 m vs. camera≈80 m, etc.). The image sensor 102a has a smaller detection range than the radar sensor 102b, and thus may not be able to detect a static object that is perceived to be spaced apart from the valid road boundary 518 by the radar sensor 102b (e.g., a far guardrail, a pole, or a distant barrier, etc.). In step S110 of FIG. 5, the second virtual road boundary 524 used in the determination of the approximation with respect to the static object does not extend to the static object, and thus the determination of the approximation may not be processed. Accordingly, even when the detection range 522 of the image sensor 102a does not reach the static object, the second virtual road boundary 524 extends to the detection range of the radar sensor 102b, and thus the determination of the approximation may be processed normally (e.g., by extrapolating the camera-based boundary using radar-derived geometry, etc.).

Referring to S110 of FIG. 5, the processor 118 may determine whether to adopt the static object as a boundary candidate based on the approximation of the virtual road boundary with the static object perceived to be spaced apart from the valid road boundary by the radar sensor 102b (e.g., cone, fence, or wall detected beyond lane markings, etc.).

According to the example of FIG. 6, the processor 118 may determine whether to select the static object as a boundary candidate based on the approximation of the virtual road boundary 512 by the radar sensor 102b with the static object perceived as being spaced apart from the valid road boundary 508.

For example, the processor 118 may determine whether the approximation condition according to the distance between the points 514 and 516 at both ends of the estimated boundary line 510 associated with the static object and the virtual road boundary 512 is met in the two-dimensional space (e.g., within a tolerance threshold such as ≤1.0 m or ≤5° angular deviation, etc.). Since the virtual road boundary 412 includes an equation according to the regression line information, the processor 118 may determine whether the distance d between the point 516 at one end and the virtual road boundary 512 is less than or equal to a first reference distance, and determine whether the distance between the point 514 at the other end and the virtual road boundary 512 is equal to or less than a second reference distance. The condition related to whether the distances of the points 514, 516 at both ends are within the first and second reference distances may be the approximation condition. Although the present disclosure illustrates that the approximation condition uses the points 514, 516 at both the ends, the approximation condition may be set in various ways (e.g., midpoint deviation, average offset, or perpendicular projection error, etc.).

The processor 118 may select the static object and/or the estimated boundary line 510 as the boundary candidate based on the approximation condition according to the distance between the points 514 and 516 at both ends and the virtual road boundary 512 being met (e.g., confirming geometric continuity between curb segment and predicted boundary, etc.). When the approximation condition is not met, the processor 118 may not adopt the static object and the estimated boundary line 510 as the boundary candidate (e.g., when the lateral gap exceeds threshold or curvature mismatch occurs, etc.).

According to FIG. 7, which relates to another example of boundary candidate selection, the processor 118 may employ the static object and/or the estimated boundary line 510 as boundary candidate based on the static object satisfying an approximation condition with either of the first virtual road boundary 512 and the second virtual road boundary 520 (e.g., radar-image boundary fusion improving redundancy, etc.). The approximation condition may be substantially the same as the example described above. According to another example, the second virtual road boundary 520 may have a higher boundary estimation than the first virtual road boundary 512, so that the boundary candidates are accurately selected, and the generation and processing of the final road boundary may be performed robustly, without missing static objects that are estimated to be continuous road boundaries (e.g., in highway merges, curved exits, or occluded corners, etc.).

Referring to S115 of FIG. 5, the processor 118 of the vehicle 100 may determine whether the unperceived area of the radar sensor 102b between the perceived road boundary and the boundary candidate on the valid road boundary is estimated to be a presence-non-detection state based on the static object (or the estimated boundary line 510) being adopted as the boundary candidate (e.g., for blind-spot inference or occlusion bridging, etc.).

The presence-non-detection state means a state in which an object undetected by the radar sensor 102b is presumed to actually exist in the surrounding environment, and may be referred to as a false-negative state (e.g., due to radar reflection loss, rain attenuation, or visual obstruction, etc.).

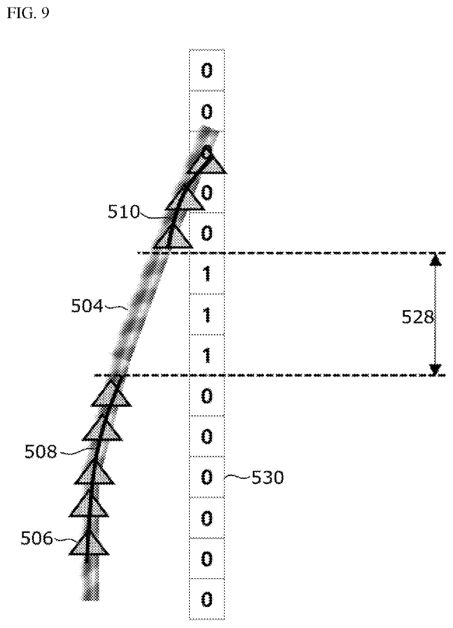

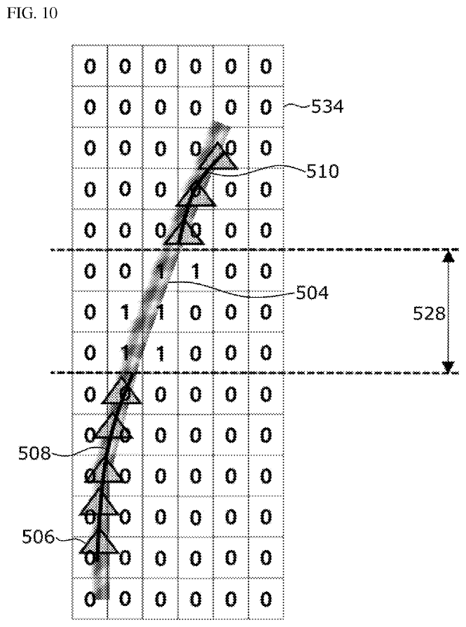

As illustrated in FIGS. 9 and 10, the processor 118 may determine that an unperceived area 528 is estimated to be a presence-non-detection state based on the number of non-detections of the subsequent actual object by the radar sensor 102b being less than or equal to an absence state value in the unperceived area 528 of the radar sensor 102b (e.g., below a predefined confidence threshold or false-negative limit, etc.). FIG. 9 shows an example related to determination of a state in an unperceived area. FIG. 10 shows an example related to determination of a state in an unperceived area.

Subsequent actual object non-detection may mean that an object in the surroundings is not actually detected through a scan of the radar sensor 102b that occurs after the object detection by the radar sensor 102b in step S105 (e.g., a guardrail temporarily occluded by another vehicle or a cone hidden by rain clutter, etc.). For example, when the radar sensor 102a detects the surrounding environment according to a plurality of scan times while the vehicle 100 is driving, data related to the presence or absence of object detection in the radar sensor 102b may be recorded for each scan time (e.g., frame-by-frame occupancy status or binary detection logs, etc.). The number of subsequent object non-detections may be counted by using the data related to the detection presence or absence recorded for each scan times (e.g., across 5-10 consecutive scans, depending on radar frequency, etc.).

The data related to the presence or absence of subsequent object non-detection may be generated on a one-dimensional grid map 530 along one direction in the two-dimensional space where the valid road boundary 508 and the estimated boundary line 510 are present, as illustrated in FIG. 9. For example, the one-dimensional grid map 530 has cells that record the data, and the actual detection of the object may be indicated as zero, and the actual non-detection of the object may be indicated as one (e.g., binary occupancy representation or temporal confidence decay, etc.). The processor 118 may identify a cell corresponding to the unperceived area 528 among cells of the one-dimensional grid map 530 to determine whether the number of actual non-detections of the object is less than or equal to the absence state value (e.g., fewer than three consecutive non-detections triggers a presence assumption, etc.).

As another example, data related to the presence or absence of subsequent object non-detection may be generated on a two-dimensional grid map 534 in a two-dimensional space in which the valid road boundary 508 and the estimated boundary line 510 exist, as illustrated in FIG. 10 (e.g., occupancy grid or bird's-eye view map for environmental modeling, etc.). For example, the two-dimensional grid map 534 has cells that record data, and the actual detection of the object may be indicated as zero, and the actual non-detection of the object may also be indicated as one. The processor 118 may identify a cell corresponding to the unperceived area 528 among the cells of the two-dimensional grid map 534 to determine whether the number of actual non-detections of the object is less than or equal to the absence state value (e.g., <threshold count per cell indicating intermittent detection loss, etc.).

The processor 118 may determine the unperceived area 528 to be an absent-undetected state based on the number of actual non-detections of the object exceeding the absent state value (e.g., sustained detection loss over multiple scans, etc.). The absent-non-detection state means that the object is not detected at the radar sensor 102b, as well as a state in which the object is estimated to be actually absent, and may be referred to as a true-negative state (e.g., an empty lane divider, cleared shoulder, or open exit ramp, etc.). This may correspond to the unperceived area 528 not being estimated to be a presence-non-detection state.

Referring to S120 of FIG. 5, the processor 118 may estimate a static object as a road boundary based on the unperceived area 528 being estimated to be a presence-non-detection state, and generate a final road boundary based on the perceived road boundary and the static object (e.g., by fusing radar-predicted curb edges with previously detected lane markings, etc.).

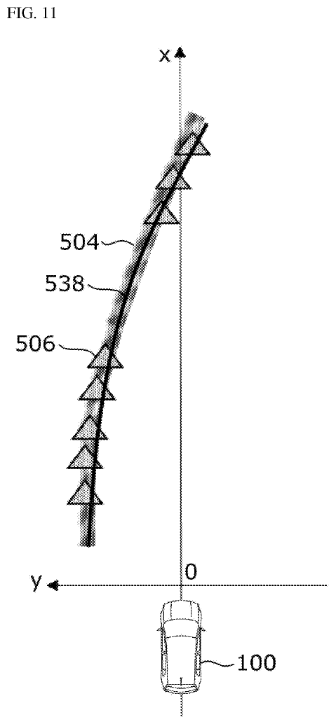

As illustrated in FIG. 11, the processor 118 may generate a final road boundary 538 by merging a static object and a perceived road boundary (e.g., perceived road boundary 508) by connecting the road boundary of the static object and the perceived road boundary (e.g., creating a continuous line between a guardrail segment and an existing lane boundary, etc.). FIG. 11 shows an example related to generation of a final road boundary.

Referring to S125 of FIG. 5, the processor 118 may generate a final road boundary based on a perceived road boundary spaced apart from a static object, based on the unperceived area 528 being estimated to be an absent-undetected state. For example, the processor 118 may generate a final road boundary based on a perceived road boundary, without merging a static object, based on the unperceived region 528 not being estimated to be a present-undetected state (e.g., lane edges are uninterrupted and no roadside structure is inferred, etc.).

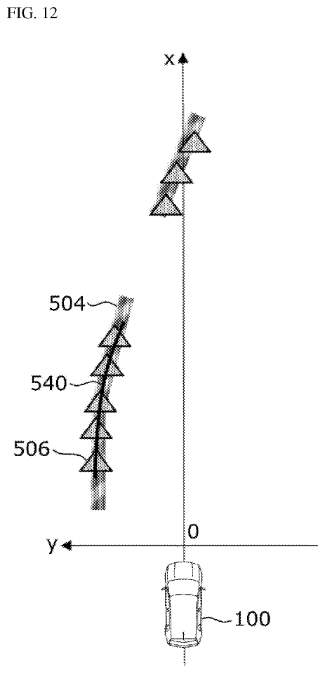

As illustrated in FIG. 12, the processor 118 may generate a final road boundary 540 depending only on a perceived road boundary (e.g., the perceived road boundary 508) without estimating a static object as a road boundary (e.g., when the roadside space is open or lacks physical structures, etc.). FIG. 12 shows an example related to generation of the final road boundary. The final road boundary 540 may be generated disconnected from the static object to match the estimated actual road boundary (e.g., aligning with a detected lane marking or roadway edge curvature, etc.).

Referring to S130 of FIG. 5, in response to the presence of another static object detected by the radar sensor 102b in addition to the static objects illustrated in FIGS. 6 to 8, the processor 118 may perform steps S105 to S125, and in response to the absence of the other static object, the processor 118 may terminate the processing of the final road boundary (e.g., once all candidate static objects within the detection range are exhausted, etc.). When the processing is terminated, as illustrated in FIG. 3, the final road boundary is processed into road boundary information by the management processing, and the vehicle 100 may be autonomously controlled based on the road boundary information (e.g., lateral control, obstacle avoidance, or adaptive path following, etc.).

According to the present disclosure, an object associated with a road boundary that is not perceived as a limitation of sensor performance may be robustly estimated to conform to the actual road boundary object 504 (e.g., maintaining continuous edge detection despite occlusion, fog, or sparse reflection zones, etc.).

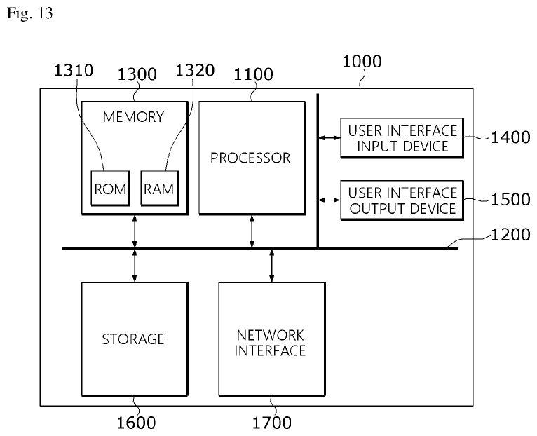

FIG. 13 shows an example computing system (e.g., a computing device of a vehicle or any other apparatus). One or more controllers, processors, etc. described herein, such as one or more components of the vehicle 100, one or more components of the server 200, one or more components of the other vehicle 400, and any other components and devices disclosed herein, may be implemented by or in the computing system as shown in FIG. 13.

A computing system 1000 may include at least one processor 1100, memory 1300, a user interface input device 1400, a user interface output device 1500, a storage 1600, and a network interface 1700, which are connected with each other via a bus 1200.

The processor 1100 may be a central processing unit (CPU) or a semiconductor device that processes instructions stored in the memory 1300 and/or the storage 1600. Each of the memory 1300 and the storage 1600 may include various types of volatile or nonvolatile storage media. For example, the memory 1300 may include a read-only memory (ROM) and a random-access memory (RAM).

Communication interface(s) (also referred to as communication device(s), communicator(s), communication module(s), communication unit(s), etc.), such as the network interface 1700, may allow software and/or data to be transferred between a device and one or more external devices, and/or between one or more components of a device. Communication interface(s) may include a receiver, a transmitter, a transceiver, a modem, a network interface and/or adapter (such as an Ethernet adapter), a radio transceiver, an antenna, a communication port, a Personal Computer Memory Card International Association (PCMCIA) slot and card, or the like. Software and data transferred via communication interface(s) may be in the form of signals, which may be electronic, electromagnetic, optical, infrared, or other signals capable of being received by communication interface(s). These signals may be provided to communication interface(s) via a communication path of a device, which may be implemented using, for example, wire or cable, fiber optics, a cellular link, a radio frequency (RF) link and/or other communications channels. Communication interface(s) may communicate using one or more communication protocols, such as Ethernet, Wi-Fi, near-field communication (NFC), Infrared Data Association (IrDA), Bluetooth, Bluetooth low energy (BLE), Zigbee, Long-Term Evolution (LTE), 5G New Radio (NR), vehicle-to-everything (V2X), a controller area network (CAN), or a local interconnect network (LIN), etc.

Accordingly, the operations of the method or algorithm described in connection with example example(s) disclosed in the specification may be directly implemented with a hardware module, a software module, or a combination of the hardware module and the software module, which is executed by the processor 1100. The software module may reside on a storage medium (e.g., the memory 1300 and/or the storage 1600) such as RAM, a flash memory, ROM, an erasable and programmable ROM (EPROM), an electrically EPROM (EEPROM), a register, a hard disk drive, a removable disc, or a compact disc-ROM (CD-ROM).

The storage medium may be coupled to the processor 1100. The processor 1100 may read out information from the storage medium and may write information in the storage medium. Alternatively, the storage medium may be integrated with the processor 1100. The processor and storage medium may be implemented with an application specific integrated circuit (ASIC). The ASIC may be provided in a user terminal. Alternatively, the processor and storage medium may be implemented with separate components in the user terminal.

According to one example of the present disclosure, there is provided a method for processing a road boundary, the method comprising: generating a virtual road boundary based on a valid road boundary generated from point cloud data of a first sensor that detects a surrounding environment of a vehicle; determining, based on approximation of the virtual road boundary with a static object perceived by the first sensor to be spaced apart from the valid road boundary, whether to adopt the static object as a boundary candidate; determining, based on the static object being adopted as the boundary candidate, whether an unperceived area of the first sensor between a perceived road boundary on the valid road boundary and the boundary candidate is estimated to be in a presence-non-detection state; generating, based on the unperceived area being estimated to be in the presence-non-detection state, a final road boundary based on the perceived road boundary and the static object; and controlling the vehicle based on the final road boundary. The presence-non-detection state is a state in which an object undetected by the first sensor is estimated to be present in the surrounding environment.

For examples, the valid road boundary may comprise at least one of a perceived road boundary and a preceding final road boundary, the perceived road boundary may be generated from the point cloud data and identified as a valid road boundary, and the preceding final road boundary may be a final road boundary generated based on point cloud data acquired at a preceding time.

For examples, the virtual road boundary may be generated by extending from the valid road boundary using regression line information based on the valid road boundary.

For examples, the determining whether to adopt the static object as the boundary candidate may comprises adopting the static object as a boundary candidate based on an approximation condition depending on a distance between points at both ends of an estimated boundary line associated with the static object and the virtual road boundary being satisfied.

For examples, the virtual road boundary may comprises a first virtual road boundary and a second virtual road boundary, the first virtual road boundary may be generated based on a first valid road boundary generated from point cloud data of the first sensor, and the second virtual road boundary may be generated based on a second valid road boundary generated by image data of a second sensor that detects the surrounding environment. Also, the determining whether to adopt the static object as the boundary candidate comprises adopting, based on that the static object meets an approximation condition with any one of the first virtual road boundary and the second virtual road boundary, the static object as the boundary candidate.

For examples, the second virtual road boundary may be generated by extending to a detection range of the first sensor that is greater than a detection range of the second sensor.

For examples, the determining whether an unperceived area of the first sensor may be estimated to be in the presence-non-detection state comprises determining that the unperceived area is estimated to be the presence-non-detection state based on a number of non-detections of the subsequent actual object by the first sensor in the unperceived area being less than or equal to an absence state value.

For examples, the generating the final road boundary may comprises estimating the static object as a road boundary; and generating the final road boundary connecting the road boundary of the static object and the perceived road boundary, so as to merge the static object with the perceived road boundary.

For examples, the determining whether the unperceived area may be estimated to be in a presence-non-detection state comprises determining, based on the unperceived area not being estimated to be in the presence-non-detection state, the unperceived area to be in an absence-non-detection state, the absence-non-detection state may be a state in which the object is not detected at the first sensor and the object is estimated to be actually absent. The method may further comprise generating a final road boundary that is based on the perceived road boundary based on the unperceived area being estimated to be in the absence-non-detection state.

For examples, the perceived road boundary may be identified by perceiving a road structure installed in a predetermined form on the road.

According to another example of the present disclosure, there is provided a vehicle, the vehicle comprising: a sensor unit including a first sensor to detect a surrounding environment of the vehicle; a memory storing at least one instruction; and at least one processor executing the at least one instruction stored in the memory. The at least one processor is configured to: generate a virtual road boundary based on a valid road boundary generated from point cloud data of a first sensor; determine, based on approximation of the virtual road boundary with a static object perceived by the first sensor to be spaced apart from the valid road boundary, whether to adopt the static object as a boundary candidate; determine, based on the static object being adopted as the boundary candidate, whether an unperceived area of the first sensor between a perceived road boundary on the valid road boundary and the boundary candidate is estimated to be in a presence-non-detection state; generate, based on the unperceived area being estimated to be in the presence-non-detection state, a final road boundary based on the perceived road boundary and the static object; and control the vehicle based on the final road boundary. The presence-non-detection state is a state in which an object undetected by the first sensor is estimated to be present in the surrounding environment.

According to the present disclosure, it is possible to provide a method and vehicle of processing a road boundary that robustly estimate objects related to an unperceived road boundary with sensor performance limitations.

Effects that may be obtained in the present disclosure are not limited to the above-mentioned effects, and other effects that are not mentioned will be clearly understood by those skilled in the art to which the present disclosure belongs from the description below.

While the exemplary methods of the present disclosure described above are represented as a series of operations for clarity of description, it is not intended to limit the order in which the steps are performed, and the steps may be performed simultaneously or in different order as necessary. In order to implement the method according to the present disclosure, the described steps may further include other steps, may include remaining steps except for some of the steps, or may include other additional steps except for some of the steps.

The various examples of the present disclosure are not a list of all possible combinations and are intended to describe representative examples of the present disclosure, and the matters described in the various examples may be applied independently or in combination of two or more.

In addition, various examples of the present disclosure may be implemented in hardware, firmware, software, or a combination thereof. In the case of implementing the present disclosure by hardware, the present disclosure can be implemented with application specific integrated circuits (ASICs), Digital signal processors (DSPs), digital signal processing devices (DSPDs), programmable logic devices (PLDs), field programmable gate arrays (FPGAs), general processors, controllers, microcontrollers, microprocessors, etc.

The scope of the disclosure includes software or machine-executable commands (e.g., an operating system, an application, firmware, a program, etc.) for enabling operations according to the methods of various examples to be executed on an apparatus or a computer, a non-transitory computer-readable medium having such software or commands stored thereon and executable on the apparatus or the computer.

What is claimed is:

1. A method performed by a vehicle, the method comprising:
obtaining, via a sensor of the vehicle, point cloud data associated with at least one static object in a surrounding environment of the vehicle;
detecting, based on the point cloud data, a road boundary;
generating a virtual road boundary by extending the detected road boundary;
determining, based on approximation of the virtual road boundary with the at least one static object, whether to select the at least one static object as a boundary candidate, wherein the at least one static object is spaced apart from the detected road boundary;
determining whether an unperceived area is in a presence-non-detection state, wherein the unperceived area is an area undetected by the sensor and located between the detected road boundary and the boundary candidate, and wherein the presence-non-detection state is a state in which an object undetected by the sensor is estimated to be present in the surrounding environment;
based on the detected road boundary, the at least one static object, and the unperceived area being in the presence-non-detection state, outputting a signal indicating a final road boundary; and
controlling, based on the signal, autonomous driving of the vehicle.

2. The method of claim 1,
wherein the detected road boundary comprises at least one of a perceived road boundary and a preceding final road boundary,
wherein the perceived road boundary is determined from the point cloud data and used as the detected road boundary, and
wherein the preceding final road boundary is a final road boundary generated based on point cloud data acquired at a preceding time.

3. The method of claim 1,
wherein the virtual road boundary is generated by extending the detected road boundary using regression line information, and
wherein the regression line information is derived from the detected road boundary.

4. The method of claim 1,
wherein the determining of whether to select the at least one static object as the boundary candidate comprises selecting the at least one static object as the boundary candidate based on a distance between a first point and a second point satisfying a threshold distance,
wherein the first point corresponds to an endpoint of an estimated boundary line associated with the at least one static object, and
wherein the second point corresponds to an endpoint of the virtual road boundary.

5. The method of claim 1,
wherein the virtual road boundary comprises a first virtual road boundary and a second virtual road boundary,
wherein the first virtual road boundary is generated based on a first detected road boundary determined from the point cloud data, and
wherein the second virtual road boundary is generated based on a second detected road boundary determined by image data, wherein the image data is obtained from a second sensor configured to detect the surrounding environment; and
wherein the determining of whether to select the at least one static object as the boundary candidate comprises selecting, based on the at least one static object satisfying an approximation condition with at least one of the first virtual road boundary or the second virtual road boundary, the at least one static object as the boundary candidate.

6. The method of claim 5,
wherein the second virtual road boundary is generated by extending a detection range of the second sensor to correspond to a detection range of the sensor, wherein the detection range of the sensor is greater than the detection range of the second sensor.

7. A vehicle comprising:
a sensor configured to obtain point cloud data associated with at least one static object in a surrounding environment of the vehicle;
a driving control circuit configured to control autonomous driving of the vehicle; and
a processor circuit configured to cause the vehicle to:
detect, based on the point cloud data, a road boundary,
generate, based on regression line information derived from the detected road boundary, a virtual road boundary,
determine, based on whether an approximation condition between a boundary line associated with the at least one static object and the virtual road boundary is satisfied, whether to select the at least one static object as a boundary candidate,
determine whether an unperceived area is in a presence-non-detection state, wherein the unperceived area is an area undetected by the sensor and located between the detected road boundary and the boundary candidate, and wherein the presence-non-detection state is a state in which an object undetected by the sensor is determined to be present in the surrounding environment,
based on the detected road boundary, the at least one static object, and the unperceived area being in the presence-non-detection state, output a signal indicating a final road boundary, and
control, via the driving control circuit and based on the signal, autonomous driving of the vehicle.

8. The vehicle of claim 7,
wherein the regression line information is derived by fitting a regression line to a plurality of boundary points included in the detected road boundary, and
wherein the virtual road boundary is generated by extending the regression line beyond an end portion of the detected road boundary.

9. The vehicle of claim 7,
wherein the approximation condition is satisfied when a distance between a first point and a second point is less than or equal to a predetermined threshold distance,
wherein the first point corresponds to an endpoint of an estimated boundary line associated with the at least one static object, and wherein the second point corresponds to an endpoint of the virtual road boundary.

10. The vehicle of claim 7,
wherein the unperceived area is determined to be in the presence-non-detection state based on a quantity of times an object in the unperceived area undetected by the sensor being less than or equal to an absence-state threshold value.

11. A vehicle comprising:
a sensor configured to obtain point cloud data associated with at least one static object in a surrounding environment of the vehicle;
a processor; and
a memory storing at least one instruction that, when executed by the processor, is configured to cause the vehicle to:
detect, based on the point cloud data, a road boundary,
generate a virtual road boundary by extending the detected road boundary,
determine, based on approximation of the virtual road boundary with the at least one static object, whether to select the at least one static object as a boundary candidate, wherein the at least one static object is spaced apart from the detected road boundary,
determine whether an unperceived area is in a presence-non-detection state, wherein the unperceived area is an area undetected by the sensor and located between the detected road boundary and the boundary candidate, and wherein the presence-non-detection state is a state in which an object undetected by the sensor is estimated to be present in the surrounding environment,
based on the detected road boundary, the at least one static object, and the unperceived area being in the presence-non-detection state, output a signal indicating a final road boundary, and
control, based on the signal, autonomous driving of the vehicle.

12. The vehicle of claim 11,
wherein the detected road boundary comprises at least one of a perceived road boundary and a preceding final road boundary,
wherein the perceived road boundary is determined from the point cloud data and used as the detected road boundary, and
wherein the preceding final road boundary is a final road boundary generated based on point cloud data acquired at a preceding time.

13. The vehicle of claim 11,
wherein the virtual road boundary is generated by extending the detected road boundary using regression line information, and
wherein the regression line information is derived from the detected road boundary.

14. The vehicle of claim 11,
wherein, in the determining whether to select the at least one static object as the boundary candidate, the at least one instruction, when executed by the processor, is configured to cause the vehicle to select the at least one static object as the boundary candidate based on a distance between a first point and a second point satisfying a threshold distance,
wherein the first point corresponds to an endpoint of an estimated boundary line associated with the at least one static object, and
wherein the second point corresponds to an endpoint of the virtual road boundary.

15. The vehicle of claim 11,
wherein the virtual road boundary comprises a first virtual road boundary and a second virtual road boundary,
wherein the first virtual road boundary is generated based on a first detected road boundary determined from the point cloud data, and
wherein the second virtual road boundary is generated based on a second detected road boundary determined by image data, wherein the image data is obtained from a second sensor configured to detect the surrounding environment, and
wherein, in the determining whether to select the at least one static object as the boundary candidate, the at least one instruction, when executed by the processor, is configured to cause the vehicle to select, based on the at least one static object satisfying an approximation condition with at least one of the first virtual road boundary or the second virtual road boundary, the at least one static object as the boundary candidate.

16. The vehicle of claim 15,
wherein the second virtual road boundary is generated by extending a detection range of the second sensor to correspond to a detection range of the sensor, and wherein the detection range of the sensor is greater than the detection range of the second sensor.

17. The vehicle of claim 11,
wherein, in the determining whether an unperceived area is in the presence-non-detection state, the at least one instruction, when executed by the processor, is configured to cause the vehicle to determine that the unperceived area is in the presence-non-detection state based on a number of times an object in the unperceived area not detected by the sensor being less than or equal to an absence state threshold value.

18. The vehicle of claim 11,
wherein the at least one instruction, when executed by the processor, is configured to cause the vehicle to:
determine the at least one static object as a portion of the road boundary, and
generate the final road boundary by connecting the portion of the road boundary and the detected road boundary, so as to merge the at least one static object with the detected road boundary.

19. The vehicle of claim 11,
wherein, in the determining whether the unperceived area is in the presence-non-detection state, the at least one instruction, when executed by the processor, is configured to:
determine that, based on the unperceived area determined to be not in the presence-non-detection state, the unperceived area is in an absence-non-detection state, wherein the absence-non-detection state is a state in which an object is not detected by the sensor and is determined to be actually absent, and
generate the final road boundary based on the unperceived area being determined to be in the absence-non-detection state and the detected road boundary.

20. The vehicle of claim 11,
wherein the detected road boundary is identified by detecting a road structure installed in a predetermined form on a road in the surrounding environment of the vehicle.
